(19) United States
(12) Patent Application Publication
(10) Pub. No.: US 2006/0064632 A1
(43) Pub. Date: Mar. 23, 2006

(54) Method and system to inverse graphs

(76) Inventor: Peter Vignet, San Francisco, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/949,999

(22) Filed: Sep. 23, 2004

(51) Int. Cl. G06F 17/24

(52) U.S. Cl. 715/502; 715/530

(57) ABSTRACT

A method and system to inverse graphs are disclosed. The system to inverse graphs includes a chart models generator to generate an initial chart model responsive to a request for an initial chart from a user; an extractor to receive a request for an inverse chart associated with the initial chart; a chart model inverser to generate the inverse chart utilizing the initial chart model; and a display component to provide the inverse chart to the user. The system may further include an inversions list generator to generate a list of one or more graph inversions associated with the initial chart model. The display component may be configured to provide this list to the user, such that the user may select a graph inversion from the list.

### FIELD OF THE INVENTION

An embodiment relates generally to enterprise resource and program management, and more particularly to a method and system to inverse graphs without a new back end call.

### BACKGROUND OF THE INVENTION

Software applications in the field of enterprise resource and program management attempt to integrate all facets of a business including planning, manufacturing, sales, and marketing. As the resource and program management methodology has become more popular, software applications have emerged to help users implement resource and program management in business activities to provide visibility into the entire portfolio of enterprise programs and projects, while supporting strategic capacity planning and resource allocation based on up-to-date information on skills and availability of the resources.

A resource and program management system may enable users to manage and execute complex information technology (IT) and research and development (R&D) projects. Such a system may, for example, integrate information from existing project management, human resources, financial, and time-tracking systems in order to provide a complete overview of a project portfolio. Business data may be presented to a user in a tabular form, as well as in a form of graphs and charts. A good user experience may result from easy rendering of business graphics in a portal page.

### SUMMARY OF THE INVENTION

A method and system to inverse graphs are described. According to one aspect, a system to inverse graphs includes a chart models generator to generate an initial chart model responsive to a request for an initial chart from a user; an extractor to receive a request for an inverse chart associated with the initial chart; a chart model inverser to generate the inverse chart utilizing the initial chart model; and a display component to provide the inverse chart to the user. The initial chart may be, for example, a stacked bar graph.

According to a further aspect, the chart model inverser may be configured to generate a table corresponding to the initial chart model, to generate an inverse chart table, and to generate an inverse chart model suitable for generating the inverse chart. The initial table may include a data series column and a categories column. The inverse table may be generated by swapping the data series column with the categories column in the initial table.

According to a still further aspect, the chart model inverser may be configured to directly manipulate the initial chart model and thereby to generate the inverse chart model suitable for generating the inverse chart. According to another aspect, the system may include an inversions list generator to generate a list of one or more graph inversions associated with the initial chart model. The display component may be configured to provide this list to the user, such that the user may select a graph inversion from the list.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIGS. 1 and 1A illustrate exemplary graphs generated by a system to inverse graphs, according to one embodiment of the present invention;

FIG. 2 is a network diagram depicting a system having a client-server architecture, according to one embodiment of the present invention;

FIG. 3 is a block diagram illustrating a system to inverse graphs in an enterprise resource and program management environment, according to one embodiment of the present invention;

FIGS. 4 and 5 are flowcharts illustrating operations performed by a method to inverse graphs, according to one embodiment of the present invention;

FIG. 6 is a diagrammatic representation of a computer system, within which a set of instructions, for causing the machine to perform any one or more of the methodologies discussed herein, may be executed.

### DETAILED DESCRIPTION

A method and a system to inverse graphs are described. In the following description, for purposes of explanation, numerous specific details are set forth in order to provide a thorough understanding of the present invention. It will be evident, however, to one skilled in the art that the present invention may be practiced without these specific details.

In a web-based environment, client web browsers may render graphs provided by servlets on a web server. Graphs may be built utilizing chart models. Chart models, in turn, may be built from table data, which may be provided by back end calls from a web server to a database server. Ordinarily, in order for a new graph to be rendered by a browser application, a new back end call is generated and a new chart model is built. The back end calls associated with each request for a graph may negatively impact back end performance. However, there may be situations where a user requests an alternative representation of the initial graph, such as, for example, an inverse graph that conveys essentially the same data as the initial graph but represents the data differently. In such situations, it may be beneficial to avoid an additional back end call by utilizing the already existing chart model.

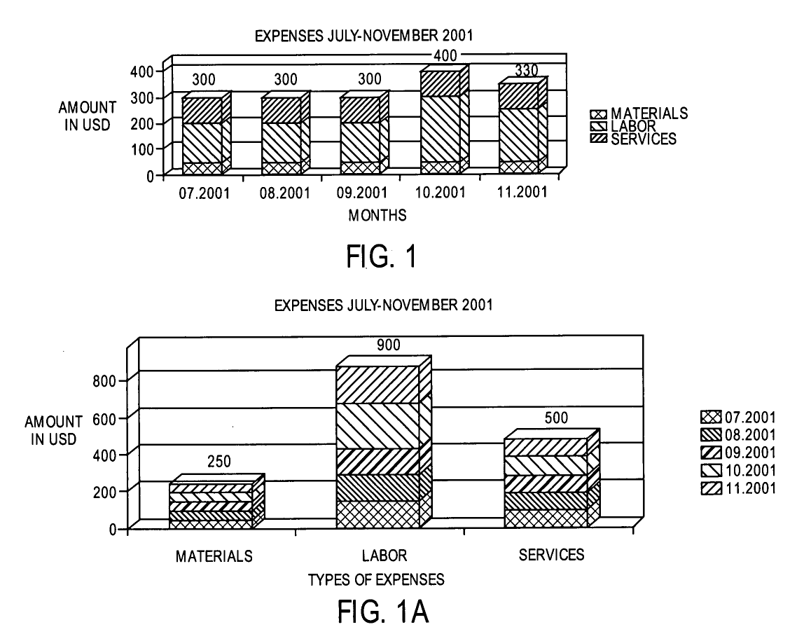

The use of inverse graphs may be illustrated by an example including graphical representation of a company's operational costs. A vertical stacked graph may represent monthly operational costs, where the value for each month is stacked as a sum of materials costs, service costs, and labor costs, as shown in FIG. 1. An inverse graph may represent costs per the type of expense, where the value for each type of expense (i.e., materials costs, service costs, and labor costs) is stacked as a sum of each month's expenses, as shown in FIG. 1A. In one embodiment, both the initial graph and the inverse graph may be generated more efficiently by utilizing the same initial chart model. Since both graphs in the example above utilize the same data (i.e., cost values per month per the type of expense), one back end call may be required for generating both the initial graph and the inverse graph, which may favorably affect back end performance.

It will be noted that one chart model, in some cases, may be utilized to generate more than one inverse graph depending on the table data underlying a particular chart model. For example, if a table containing the company's monthly operational costs, retrieved by a back end call to generate the initial graph of FIG. 1, includes values for costs per department in addition to monthly operational costs and costs per the type of expense, then the initial chart model may be utilized to generate yet another inverse graph representing monthly costs per type of expense and department.

In one embodiment, the system and method to generate graphs may be implemented utilizing an HTML-Business for Java (HTMLB) control, such as a chart control. The chart control, in one embodiment, may include a plurality of properties, such as a chart type property, data source property, scaling property, axis title properties, and a legend position property. The type chart property determines the type of graphics, such as a pie chart, a bar graph, an area graph, as well as other types of graphics. The chart control is “data driven”, i.e. it relies heavily on the concept of data binding. Thus, the data source property is assigned to a suitable external table. A suitable table, in one embodiment, includes at least the following:
The name of the data series (wherein each data series corresponds to an associated data set);
A column containing the x-values (X) (e.g., categories);
A column containing the y-values (Y);
A column containing optional z-values (Z);
An optional color; and
An optional extension.

The chart control may be utilized to display multiple data sets at the same time to allow, for example, comparison of operation costs associated with materials with operational costs associated with labor, as illustrated in FIGS. 1 and 1A. In one embodiment, the chart control may display categories in different colors taken from a number of predefined color schemes. Any table containing the above-mentioned columns is accepted, in one embodiment, as data source, even if the table also includes other columns as well. The scaling property determines the scaling of the y-axis. Furthermore, the chart control may provide a title, a legend, as well as labels for x-axis and y-axis. The axis title properties determine a title for categories (x-axis) and a title for values (y-axis). In the example illustrated in FIG. 1, the title for categories is “Months”, and the title for values is “Amount in USD”. A legend, such as the legend in FIG. 1, may be created automatically from names and colors of the corresponding data series. The position of the legend with respect to the graph may be set explicitly with the legend position property.

The chart control may be based on a Java applet. Thus, the usual style sheet customizing used by other HTMLB components may not be applicable to the chart control. In order to allow customization, the chart control may simulate at least a subset of cascading style sheets (CSS) attributes, such as color and font attributes.

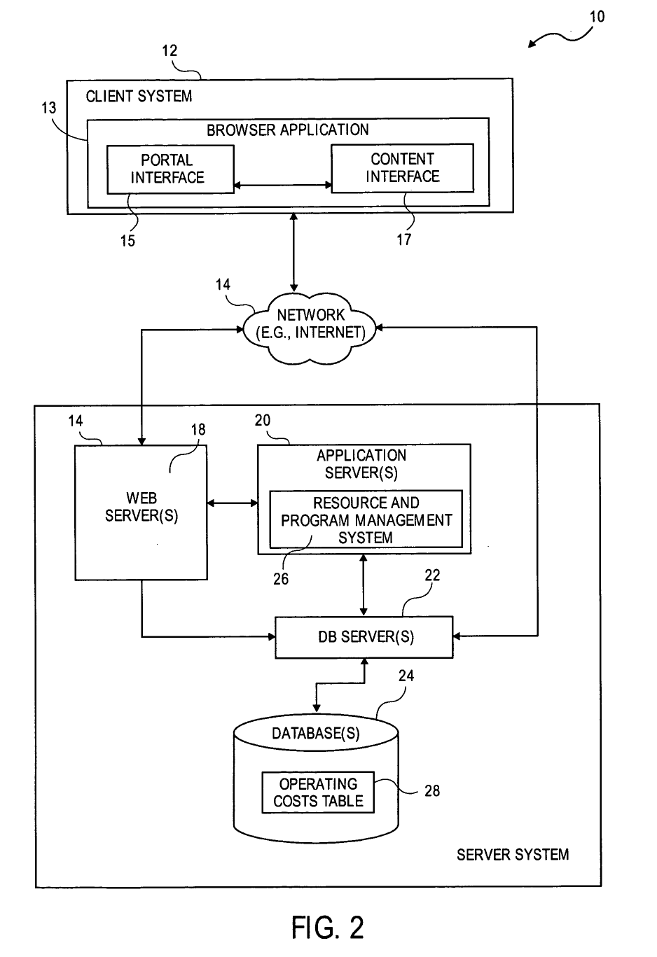

The system to inverse a graph may be implemented within a system 10 having client-server architecture, as illustrated in FIG. 2. The system 10 includes a client system 12 coupled via a network 14 (e.g., the Internet or an intranet) to a server system 16, so as to facilitate communications (e.g., utilizing any one of a number of well-known network communication protocols, such as HTTP) between the client system 12 and the server system 16. The client 12 may be any computing device, including a laptop computer, notebook computer, personal digital assistant (PDA), or handheld wireless phone. The client system 12 may further host a number of client applications, such as a browser application 13 (e.g., MS EXPLORER®, developed by Microsoft Corporation of Redmond, of Washington State). The browser application 13 may include a portal interface and a content interface.

The server system 16, in one exemplary embodiment, may include a web server 18, an application server 20, and a database (DB) server 22. The database server 22 may be connected a database 24. The application server 20 may be deployed to support one or more applications, and may utilize the database server 22 to store and to retrieve data from a database 24. In one embodiment, the application server 20 hosts an application (e.g., a resource and program management system 26), which may be utilized, for example, to enable a user to view graphical representation of business data as a chart (e.g., as a table, as a bar graph, or as a pie chart). The database 24 may, for example, store data such as project information in an exemplary form of operating costs table, and other information. The data within the database 24 may be stored in any one of a number of forms, such as, for example, flat files, relational tables objects, or as XML (extensible Markup Language) data structures. The application servers 20 may also be coupled to one or more web server 18s, so as to facilitate the delivery of web content, including content containing embedded code, such as Java, to the portal interface 15 and the content interface 17.

In one exemplary embodiment, the portal interface 15 may facilitate user access to one or more applications hosted on the application server 20, such as a resource and program management system 26. The portal interface 15 is shown to invoke the content interface 17 within which content associated with a web-based application may be presented to a user. Specifically, the content interface 17 may communicate with the one or more applications hosted on the application server 20, at least one of which may be responsible for the delivery of content to the content interface 17. Both the portal interface 15 and the content interface 17 may communicate with the server system 16 via the network 14.

Responsive to a request for a chart from the browser application 13, in order to generate a chart model, the resource and program management application obtains chart data via the web server 18 making a back end call to the database server 22. If a new graph is requested, a new chart model may be required and therefore the web server 18 may need to make another back end call to the database server 22 in order to obtain chart data suitable for generating a new chart model. In one embodiment of the present invention, the system 26 may utilize an existing chart model to generate inverse graphs and thus the inverse graphs may be generated without the need for an additional back end call.

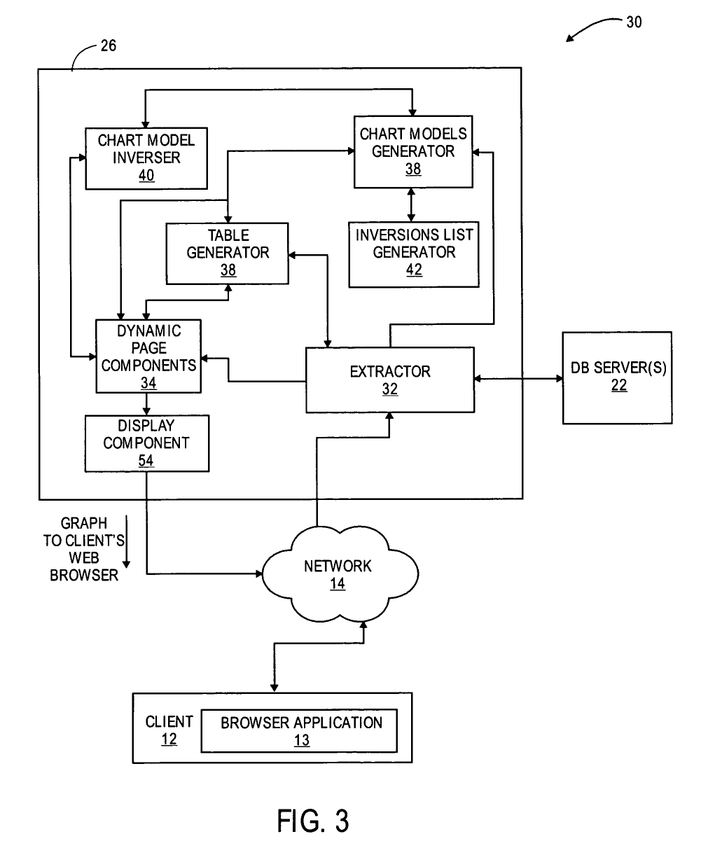

FIG. 3 is a block diagram illustrating a system 26 to inverse a graph, according to one embodiment of the present invention. In one embodiment, a business platform, in the exemplary form of the network-based resource and program management system 26, provides server-side functionality, via the network 14 (e.g., the Internet) to the one or more clients 12. The resource and program management system 26 may be configured to provide a number of business management functions and services to users.

Specifically, the system 26 allows the client 12 to request and receive a graphical representation of business data. The resource and project management system 26 may include an extractor 32, dynamic page components 34, a table generator 36, a chart models generator 38, a chart model inverser 40, an inversions list generator 42, and a display component 54. The extractor 32 may be configured to receive a client's request for a chart in accordance with the client's business data and to receive chart data associate with the requested chart (e.g., via the web server 18 making a back end call in order to retrieve appropriate chart data). If the requested chart is not an inversion of a previously rendered chart, the chart is referred to as an initial chart. The client's business data (including the chart data) may be stored in the database 24. The extractor 32 provides the chart data to the dynamic page component, which, in turn, provides this data to the chart models generator 38.

The dynamic page component 34 may generate dynamic web pages and provide them to the display component 54. In order to provide a chart representation of data (e.g., a bar graph) within a dynamic web page, the dynamic page component 34 requests one or more chart models to be generated by the chart models generator 38. Thus, when the system 26 receives a request for an initial chart, a back end call is made to the database server 22 to obtain chart data, the extractor 32 receives the chart data, and the chart models generator 38 generates an initial chart model. The initial chart model is utilized by the dynamic page component 34 to generate a web page including the initial chart. The chart models generator 38 may utilize the inversions list component to generate a list of possible inverse charts (inversions) associated with the initial chart. The list of possible inversions may be presented to the user, in an exemplary form of a drop down list, along with the initial chart.

When the system 26 receives a request for an inverse chart associated with the initial chart (e.g., when a user selects an inversion from the drop down list), the chart model inverser 40 may be configured to generate an inverse chart model without a need for a back end call. The dynamic page component 34 then utilizes the inverse chart model to generate a web page containing the inverse chart.

It will be noted that in some cases the chart model inverser 40 may be able to manipulate a chart model (e.g., the initial chart model) directly. In other cases, the chart model inverser 40 may need to extract data associated with the initial chart model, generate a tabular representation of such data (thereby creating a new table), and generate an inverse chart model utilizing the newly created table. In one exemplary embodiment, the chart model inverser 40 may manipulate a chart model directly, if the chart model is a vector chart model or a default chart model. A vector chart model and a default chart model can be inversed directly, by swapping the chart model columns.

In the example of FIGS. 1 and 1A, the table corresponding to the chart model for the stacked graph of FIG. 1, includes a data series column (here, the types of expenses), a categories column (here, months), and a values column. The values column includes an amount in USD for each type of expense in the first column per each month in the second column. In order to generate the inversion of the stacked bar graph illustrated in FIG. 1A, the chart model inverser 40 swaps the data series column and the categories column in the table corresponding to the chart model and generates an inverse chart model utilizing the table with the swapped columns.

If, in one embodiment, a chart model is a Java connector (JCO) chart model, an extra step may be required. Specifically, the chart model inverser 40 may place the data of the JCO chart model in a JCO table, swap the columns in the JCO table, and then create a new JCO chart model to be utilized by the dynamic page component.

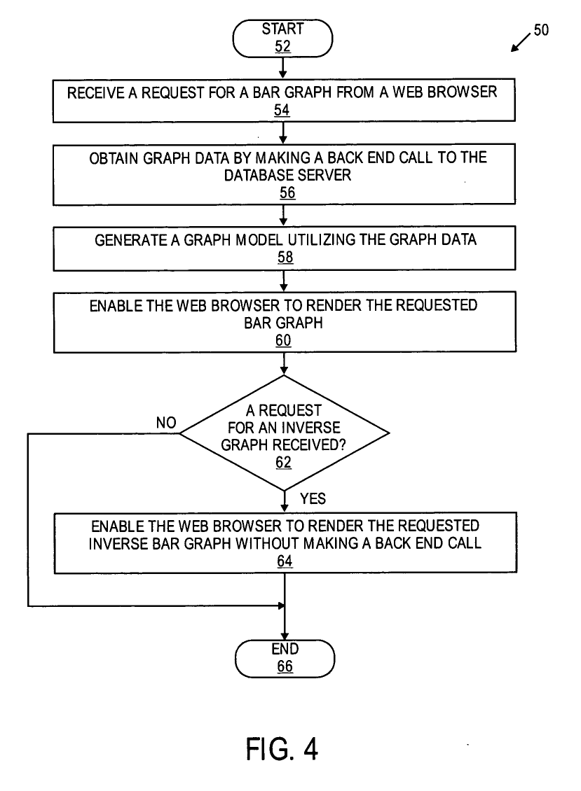

FIG. 4 is a flow chart illustrating a method 50 to inverse graphs, according to one embodiment of the present invention. The method 50 commences at operation 52. At operation 54, an application such as the resource and program management system 26 receives a request from the browser application 13 for a bar graph (e.g., a vertical stacked bar graph). Responsive to the receiving of the request for a stacked bar graph, the system 26 obtains data necessary to generate the requested bar graph. The data may be obtained by means of the web server 18 making a back end call to the database server 22. The graph data is obtained at operation 56 and utilized by the system 26 to generate a chart model at operation 58. The dynamic page component 34 then uses the chart model in order to provide the chart within a dynamic web page. The dynamic web page is provided to the browser application 13 thereby enabling the browser application 13 to render the requested bar graph at operation 60.

The system 26 may monitor requests from the browser application 13 to determine whether a request for an inverse graph has been received. Because an inverse graph utilizes the same data as an initial graph, the system 26 may be configured to process the request for the inverse graph without a need for a backend call. At operation 62, if the system 26 determines that a request for an inverse graph has been received, the inverse graph is generated utilizing the already existing chart model and the browser application 13 is enabled to render the requested inverse bar graph at operation 64. The method 50 ends at operation 66.

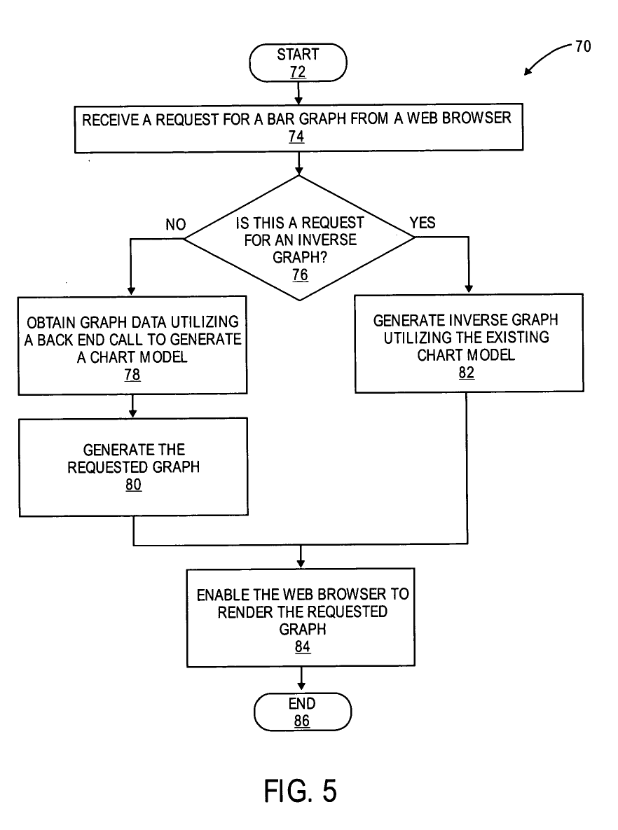

FIG. 5 illustrates a method 70 to generate a graph responsive to a user's request for a graphical representation of business data. The method 70 commences at operation 72. At operation 74, the extractor 32 receives a request from the browser application 13 for a graph. At operation 76, a determination is made whether the request for the graph is a request for an initial graph (e.g., a graph that is not related to a graph that has already been rendered by the browser application 13) or a request for an inverse graph. If it is determined, at operation 76, that the request is not for an inverse graph, but for an initial graph, the system 26 obtains graph data at operation 78, which may require a back end call, and then generates the requested graph at operation 80. If a determination is made, at operation 76, that the request is a request for an inverse graph, the inverse graph may be generated at operation 82, utilizing the already existing chart model, without the need for a backend call and the system 26. At operation 84, the browser application 13 is enabled to render the requested graph. The method 70 ends at operation 86.

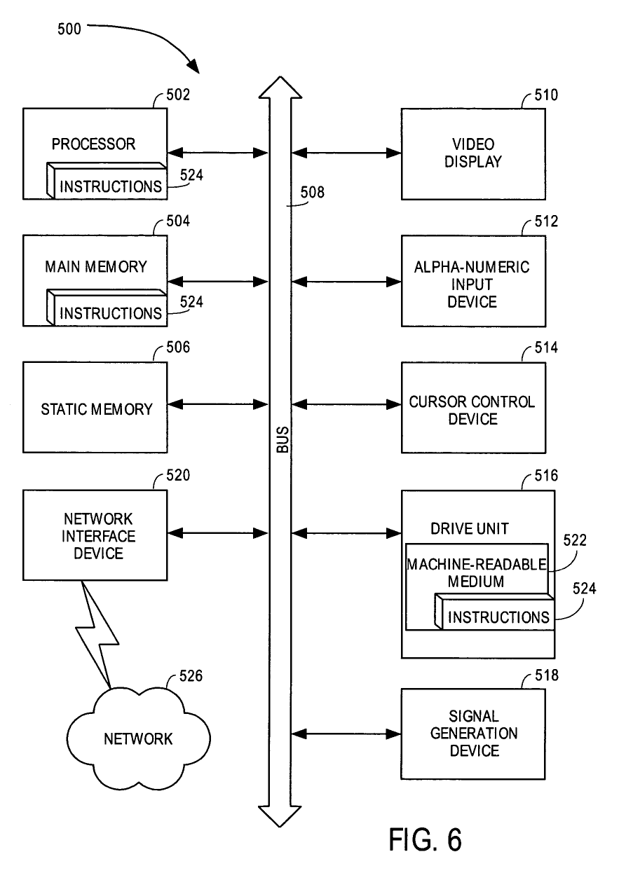

FIG. 6 illustrates a diagrammatic representation of machine in the exemplary form of a computer system 500 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processor 502 (e.g., a central processing unit (CPU) a graphics processing unit (GPU) or both), a main memory 504 and a static memory 506, which communicate with each other via a bus 508. The computer system 300 may further include a video display unit 510 (e.g., a liquid crystal display (LCD) or a cathode ray tube (CRT)). The computer system 300 also includes an alphanumeric input device 512 (e.g., a keyboard), a cursor control device 514 (e.g., a mouse), a disk drive unit 516, a signal generation device 518 (e.g., a speaker) and a network interface device 520.

The disk drive unit 516 includes a machine-readable medium 522 on which is stored one or more sets of instructions (e.g., software 524) embodying any one or more of the methodologies or functions described herein. The software 524 may also reside, completely or at least partially, within the main memory 504 and/or within the processor 502 during execution thereof by the computer system 300, the main memory 504 and the processor 502 also constituting machine-readable media. The software 524 may further be transmitted or received over a network 526 via the network interface device 520.

While the machine-readable medium 522 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and a system to generate inverse graphs have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather.

What is claimed is:

1. A system to create a chart, including:
a chart models generator to generate an initial chart model responsive to a first request for an initial chart from a user;
an extractor to receive a second request for an inverse chart associated with the initial chart;
a chart model inverser to generate the inverse chart utilizing the initial chart model; and
a display component to provide the inverse chart to the user.

2. The system of claim 1, wherein the chart model inverser is to generate an inverse chart model to be utilized to generate the inverse chart.

3. The system of claim 2, wherein the chart model inverser is to directly manipulate the initial chart model and thereby to generate the inverse chart model suitable for generating the inverse chart.

4. The system of claim 1, wherein the initial chart is a stacked bar graph.

5. The system of claim 2, wherein the chart model inverser is to:
generate a table corresponding to the initial chart model, the table including a data series column and a categories column;
generate the inverse table by swapping the data series column with the categories column; and
generate the inverse chart model utilizing the inverse table, the inverse chart model to be utilized to generate the inverse chart.

6. The system of claim 5, wherein the initial chart model is a Java connector chart model.

7. The system of claim 1, including an inversions list generator to generate a list of one or more graph inversions associated with the initial chart model.

8. The system of claim 7, wherein the display component is to provide the list of one or more graph inversions to the user, such that the user is enabled to select a graph inversion from the list of one or more graph inversions to generate the second request for the inverse chart associated with the initial chart.

9. A method to create a chart, including:
generating an initial chart model responsive to a request for an initial chart from a user;
receiving a first request for an inverse chart associated with the initial chart;
generating the inverse chart utilizing the initial chart model; and
providing the inverse chart to the user.

10. The method of claim 9, wherein the generating of the inverse chart includes generating an inverse chart model.

11. The method of claim 10, wherein the generating of the inverse chart includes directly manipulating the initial chart model, thereby generating the inverse chart model suitable for generating the inverse chart.

12. The method of claim 9, wherein the initial chart is a stacked bar graph.

13. The method of claim 10, wherein the generating of the inverse chart includes:
generating a table corresponding to the initial chart model, the table including a data series column and a categories column;
generating an inverse table by swapping the data series column with the categories column; and
generating the inverse chart model utilizing the inverse table, the inverse chart model to be utilized to generate the inverse chart.

14. The method of claim 13, wherein the initial chart model is a Java connector chart model.

15. The method of claim 9, including generating a list of one or more graph inversions associated with the initial chart model.

16. The method of claim 15, including providing the list of one or more graph inversions to the user, thereby enabling the user to select a graph inversion from the list of one or more graph inversions to generate the second request for the inverse chart.

17. A machine-readable medium having stored thereon data representing sets of instructions which, when executed by a machine, cause the machine to:
generate an initial chart model responsive to a first request for an initial chart from a user;
receive a second request for an inverse chart associated with the initial chart;
generate the inverse chart utilizing the initial chart model; and
provide the inverse chart to the user.

18. A method to create a chart, including:
means for generating an initial chart model responsive to a first request for an initial chart from a user;
means for receiving a second request for an inverse chart associated with the initial chart;
means for generating the inverse chart utilizing the initial chart model; and
means for providing the inverse chart to the user.
